(19) United States
(12) Patent Application Publication
(10) Pub. No.: US 2005/0138387 A1
(43) Pub. Date: Jun. 23, 2005

(54) System and method for authorizing software use

(76) Inventors: Wai T. Lam, Jericho, NY (US); Xiaowei Li, Hauppauge, NY (US)

Correspondence Address: Robert Greenfeld, Esq.;Kaye Scholer LLP, 425 Park Avenue, New York, NY, 10022-3596, US

(21) Appl. No.: 10/741,182

(22) Filed: Dec. 19, 2003

(51) Int. Cl. H04K 1/00

(52) U.S. Cl. 713/185

(57) ABSTRACT

A software vendor freely distributes software to users and issues smart cards to be used with the software. The smart card includes at least one software module missing from the software package and a list of allowed functionality dictating the capabilities of the software package. A user authenticates, using, e.g., public key cryptography, the smart card, which authorizes the use of the software. Once authorized, the module missing from the software is reunited with the rest of the software package. The software can be used limited to the allowed functionality included with the card. If more or different functionality is needed, the user can purchase another card authorizing such additional functionality, and then transfer the new functionality to the old smart card.

### BACKGROUND OF THE INVENTION

This invention relates generally to a system and method for authorizing software use. More particularly, this invention relates to authorizing software use with smart cards.

Licensing software, especially in an enterprise environment, has proven rather difficult, chiefly because of the very nature of software products, which can be copied with 100% integrity. Many licensing schemes, including schemes requiring the consistent presence of Internet connectivity while operating the software, have been attempted, but have failed for one reason or another.

One way to protect software is to use a data encryption algorithm, such as that found in U.S. Pat. No. 4,634,807 to Chorley et al. This patent discloses encrypting an important module of a software package using, for example, the Data Encryption Standard (DES) algorithm and a DES key. Both are also required to decrypt the module. The decryption key is encrypted using a different technique, for example, a public-key algorithm such as the RSA (Rivest-Shamir-Adelman) scheme, together with the RSA public-key of a public/private key pair. The corresponding secret key is stored securely in a software protection device (SPD). The secret key is used to decrypt the DES key, which is then used to decrypt the secure software module, and this module is then stored for use in the software package. This method encrypts the software module only.

One way of overcoming the software-licensing problem is to include a physical object with the software. Such a method of protecting software is found in U.S. Pat. No. 4,683,553 to Mollier. The method in this patent includes distributing a non-executable copy of the program and issuing to each user a card. Such a card has processing circuits and a storage area in which a secret code known only to the supplier and particular to each user has been recorded. Associated with each program is a predetermined validation key defined in accordance with the software program and with the secret code contained in the user's card, so as to make the program executable once the card is coupled or connected to the user's machine.

Another method of protecting software is found in U.S. Pat. No. 6,308,270 to Guthery. This patent discloses a method of validating execution of a software program. The method includes executing the software program on a computer, sending information from the computer to a smart card during execution of the software program, verifying in the smart card information received from the computer, and storing a signal in the smart card indicative of whether execution of the software program is certified as valid. The information sent by the computer can also identify memory addresses in the computer in which specified data is stored, and the smart card can verify whether the memory addresses are permissible memory locations for the specified data.

### SUMMARY OF THE INVENTION

The present invention authorizes the use of a software package or program distributed to a user by issuing to the user a smart card granting access to the software package and granting the user rights to the software package by authenticating the smart card. The smart card includes at least one software module missing from the software package as well as a list of allowed software functionality. The authenticating may be performed using biometrics, such as using a user's thumbprint or iris scan, or asymmetric cryptography, such as public key cryptography. In a public key cryptography embodiment, issuing a smart card involves generating a public key and private key pair for the smart card, issuing a digital certificate for the smart card, including the smart card's public key, digitally signing the smart card certificate to produce an encrypted digest, issuing a digital certificate for the vendor of the software package, and loading onto the smart card the public and private key pair, the smart card certificate, the encrypted digest, and the vendor's certificate. Digitally signing the smart card certificate preferably involves generating a digest of the smart card certificate using a hash function and encrypting the digest using a private key of the vendor. Authenticating the smart card then involves decrypting the encrypted digest to generate a first digest, generating a second digest by running a hash function on the smart card certificate, and comparing the first digest to the second digest. If the first digest and the second digest are the same, the public key of the smart card certificate is authentic.

The allowed software functionality preferably supports at least one client and may support mirroring and/or replication. The software package is made operable by incorporating the missing module found on the smart card into the software package. In another embodiment, the allowed software functionality may be changed by issuing a new smart card having its own list of allowed functionality. Functionality may be transferred from one smart card to another. In addition, the present invention may be used to authorize the use of software on a standalone computer or on a computer network.

There are several advantages to licensing software by authenticating a smart card. First, the invention provides information concerning software options (“allowed software functionality”), which include features, functions, capabilities limitations, and other information necessary for implementing and enforcing software licensing. Second, the licensing material is provided to each individual machine for the machine to be able to activate the software. Third, individual software options can be activated individually by licensing material provided for that specific option only. Fourth, individual licensed items can be individually distributed with individual smart cards. Multiple licensed items can be consolidated to a single smart card. Fifth, licensed items from one smart card can only be transferred to another smart card. Once the contents are transferred out, the original smart card will no longer have the licensed items. The transfer process also ensures that the contents to be transferred to the designated smart card can only be imported by the designated smart card. In addition, once the smart card imports the items, it will not import the same package again.

Additional advantages of the invention will be set forth in the description which follows, and in part will be apparent from the description, or may be learned by practice of the invention. The advantages of the invention may be realized and obtained by means of the instrumentalities and combinations particularly pointed out in the appended claims.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 is a block diagram illustrating the entities involved in licensing software in accordance with an embodiment of the present invention;

FIG. 2 is a schematic diagram illustrating a method for authorizing software use in accordance with an embodiment of the present invention;

FIGS. 3A and 3B are schematic diagrams illustrating authentication of a smart card in accordance with an embodiment of the present invention;

FIG. 4 is a schematic diagram illustrating an option list in accordance with an embodiment of the present invention;

FIGS. 5A-5E are schematic diagrams depicting the process of transferring options in accordance with an embodiment of the present invention; and

FIG. 6 is a block diagram illustrating a networked computer system operating in accordance with an embodiment of the present invention.

### DETAILED DESCRIPTION

The present invention uses a smart card in combination with an authentication infrastructure to provide a software licensing system designed to control the distribution of a software package. Smart cards provide a convenient yet secure way of transporting and storing sensitive information used in the authentication infrastructure. The software is freely distributed and copied, but software use is controlled by selling authorized, irreproducible smart cards, and authenticating the smart card before being able to use the software.

One type of authentication infrastructure is public key infrastructure (PKI), and it will be used to illustrate the principles of the invention. PKI lays the foundation for a well-established system of authentication and authorization. Combining the capabilities of smart cards and PKI produces a new scheme of licensing that provides the level of security and flexibility that is unrealizable in pure software licensing. PKI will be described further, as will smart card technology, followed by the ways in which these elements are combined. PKI is a system of issuing and servicing authentication and authorization applications using public key cryptographic technologies. PKI involves the following basic elements: public and private keys and key pairs, a one-way hash message digest, digital signatures, digital certificates, and certificate authorities.

“Keys” are issued in public/private pairs. What is encrypted with one key (public or private) can only be decrypted with the other key (private or public). This type of encryption, called “public key cryptography,” uses “asymmetric” keys, as compared to “secure key cryptography” which uses the same key to encrypt and decrypt (“symmetric” key).

A “one-way hash message digest” is generated when a hash algorithm takes a large chunk of data and compresses it into a digest of the original data. A preferred hash algorithm is substantially collision-free, which means that it is robust enough that there is only an infinitesimal theoretical probability of collision, i.e., that another chunk of data happens to produce the same digest.

A “digital signature” is a message digest encrypted using the private key of a public key pair in which the public key is known and trusted. The successful decryption of the message digest using the known and trusted public key ascertains the integrity and authenticity of a message. A “digital certificate” is a standard data format for associating between the organizational identity of an individual or network resource and its public key. A digital certificate is usually signed digitally by a trusted “certificate authority” (CA), which provides the infrastructure to ensure the authenticity of the issued certificates. A “certificate authority” is a trusted authority responsible for creating and certifying identities bound to the public key by signing the digital certificate with its private key, and by providing pervasive and trusted access to its own public key, in the form the of a “root certificate.”

A “smart card” is a credit-card sized plastic card containing an integrated circuit chip. The chip may come in one of two forms, contact and contactless, and the chip may contain memory only, memory with security logic, or memory with a CPU. The smart card of the present invention is preferably the latter. Electronic properties and transmission characteristics of smart cards are defined by the ISO 7816 standard series.

Smart cards have mainly been used to store and retrieve data as well as to run applications, and the possibilities are continuously expanding. With security intrinsically built in, the smart card offers protection of its content and renders itself tamper-resistant. Due to its attractive security capabilities, smart card technology has been deployed extensively for financial transactions, cable TV subscriptions, phone cards, online securities, etc.

Many standards exist for smart cards and their development tools, some of which are fundamental and can be used in all applications; and others of which are proprietary and are tied to particular vendors. As an illustrative example, one of the major smart card standards is “Java Card,” which is simply a regular smart card that allows Java technology to run on it. By specifying the Java application environment to numerous cooperating smart card manufacturers, and providing a set of application programming interfaces (APIs) and tools for programming in such an environment, Java Card allows developers to create applications that will run on any Java Card technology-enabled smart cards across a range of vendors, thus benefiting from the inherent advantages of the Java language itself. Moreover, Java Card technology has a built-in framework to work with card vendors on cryptography algorithms and PKI functionalities that are essential to licensing using smart cards.

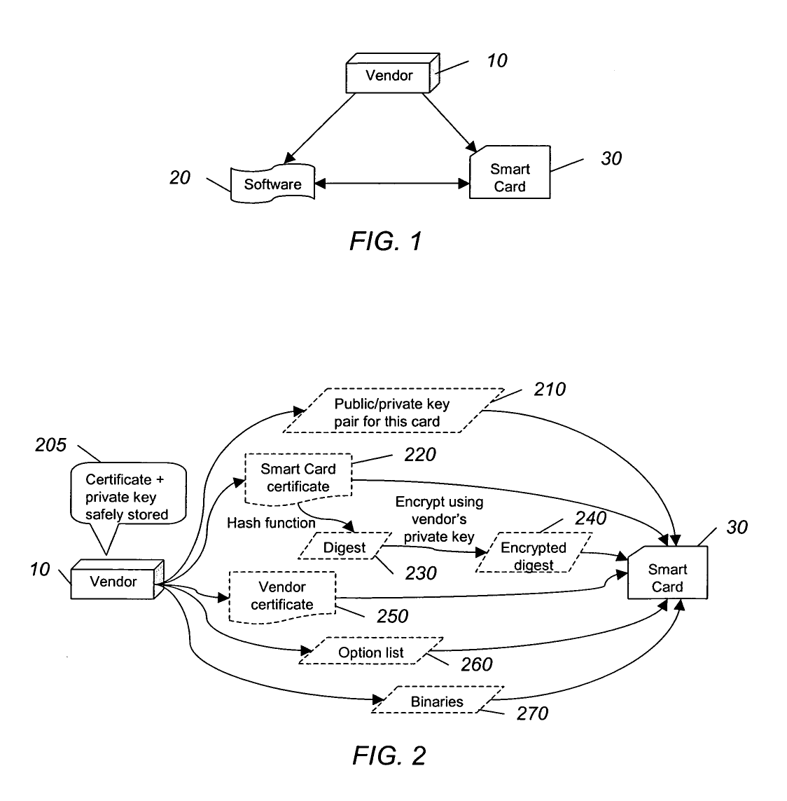

The smart card licensing scheme of the present invention includes three main entities shown in FIG. 1: the software vendor 10 (i.e., licensor), the software (or software package) 20 (i.e., licensed product), and a smart card 30 (i.e., license). Licensing requires successful and secure exchanges of information among the three entities at appropriate times. As FIG. 1 indicates, the present invention involves vendor 10 issuing both software 20 and smart card 30 and interactions between software 20 and smart card 30 involving activation of software 20, operation of software 20, and addition and transfer of software options from the card to the software.

Smart Card Issuance

The software is freely distributed and can be freely obtained, e.g., through CD-ROMs or downloads from a website. The software alone does not provide fully functional service options, and thus cannot be used by itself. The presence of a legitimate smart card 30 issued by software vendor 10 is necessary to unlock the software's functionality.

When a user purchases a software license, he or she specifies the service options (allowed software functionality) desired, which are then placed on the smart card. The type and number of options from which to choose may vary based on the type of software. One option that may be included on software of any kind is the number of machines on which the software may operate (herein called “client support”). On software designed for assisting with a user's data storage needs, the illustrative example used herein, the software options may include mirroring, replication, and/or time marking (i.e., creating periodic, scheduled, point-in-time copies of data volumes). Once these service options are specified, software vendor 10 issues smart card 30 containing licensing material for those options.

Prior to issuing smart card 30, software vendor 10 performs several tasks, generally as illustrated in FIG. 2. First, vendor 10 safely stores the vendor's digital certificate and private key, as shown in 205. The vendor's digital certificate may be issued by a higher-level certificate authority (CA) or it may be a “root” certificate, which is issued and certified by vendor 10 itself rather than another CA. Next, the vendor generates a public/private key pair 210 and stores it on smart card 30. This key pair 210 is unique to each smart card 30. The keys are randomly generated and securely exported to each card along with an associated smart card certificate 220 for the public/private key pair. Smart card certificate 220 includes the card's public key. Digital certificates such as smart card certificate 220 can be generated using any of a number of existing APIs. For example, the protocol OpenSSL (see www.openssl.org) includes a command line tool to generate digital certificates.

Vendor 10 digitally signs certificate 220 by (1) performing a one-way hash function on certificate 220 to generate digest 230 and (2) encrypting digest 230 using the vendor's private key to generate encrypted digest 240, which is also loaded onto smart card 30. This digital signature ensures that certificate 220 is indeed from software vendor 10, while the hash function helps verify the integrity of that certificate's content. Examples of popular hash functions that may be used are MD-5 (“message digest 5”), created by RSA Laboratories, and SHA-1 (“secure hash algorithm”), developed by the U.S. National Institute of Standards and Technology (NIST).

Next, vendor 10 populates smart card 30 with a copy 250 of the vendor's digital certificate (which includes the vendor's public key), which will be used to validate the correct public key of vendor 10 when needed. If certificate 250 is a root certificate (i.e., no CA has signed it), vendor 10 may create many resources for verifying the certificate by, for example, distributing a copy of certificate 250 in each smart card 30 issued, publishing certificate 250 on the vendor's corporate website and possibly other authoritative websites, maintaining another copy of certificate 250 inside the software, and providing phone support for verification, in order to prevent someone from attempting to issue a phony certificate. The certificate is the same for every smart card for a specified software package 20. However, the certificate may differ from one software package to another.

Next, vendor 10 populates smart card 30 with a list of symbols 260 that the software will interpret to determine the licensed service options for this card. Finally, a cluster of binary software modules (“binaries”) 270, sections of code extracted from the software, is placed on smart card 30. These sections of code are missing from the actual software package 20. Smart card 30 is then shipped along with a card acceptance device (e.g., a card reader), and is ready to interact with the licensed software 20 loaded onto a user's machine.

Activation of the Software

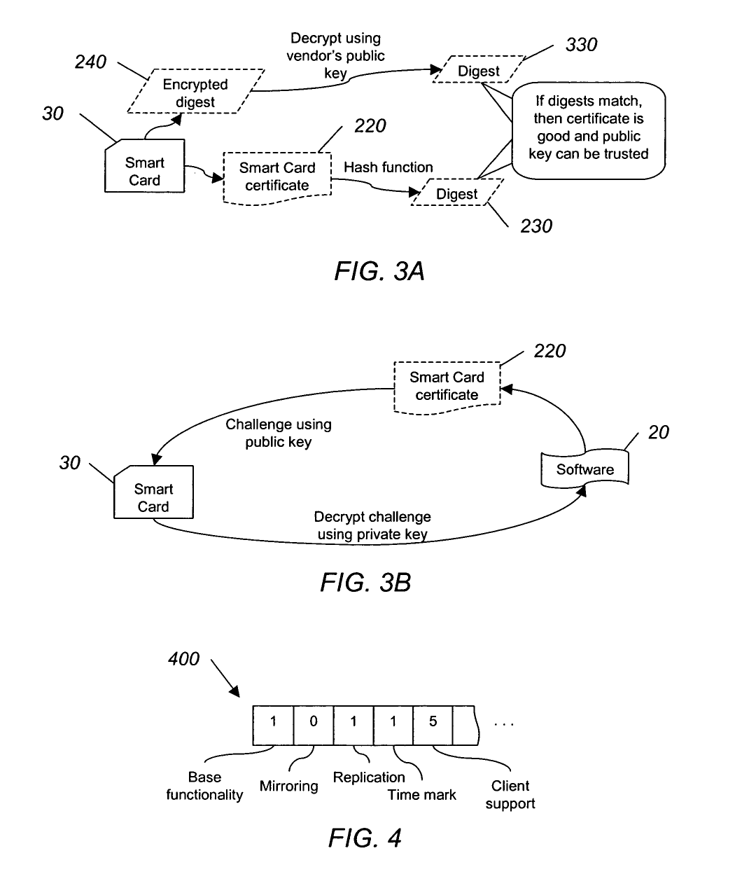

After smart card 30 is issued with the items described above, the software must be activated by authenticating the smart card. Once the user launches software 20, the software first checks whether there is a smart card to read from. After software 20 confirms a card's presence, the activation stage begins, as illustrated in FIG. 3A. The first step is for software 20 to extract smart card certificate 220 and validate it. Using vendor 10's public key from vendor certificate 250, software 20 decrypts encrypted digest 240 (which had been encrypted with the vendor's private key) to generate digest 330. If the decryption works, then vendor 10 is indeed the author. Next, software 20 performs a one-way hash on smart card certificate 220 itself using the same hash algorithm as was used in issuing the certificate, and generates another digest 230. The software then compares the two digests 230 and 330. If they match, the software can trust that the content of smart card certificate 220 has not been tampered with since the time vendor 10 digitally signed it.

The authenticated certificate 220 then tells software 20 what the card's public key is. As illustrated in FIG. 3B, given this information, the software then confirms that smart card 30 is the correct card associated with the public key by sending smart card 30 a challenge—something encrypted using the card's public key—and waiting for a satisfying response. If smart card 30 correctly decrypts the challenge using its securely stored private key and responds back, it has passed the test. At this point, software 20 believes smart card 30 to be legitimate and uses it to determine which software options should be activated.

As mentioned earlier, the smart card contains a list of symbols 260, with each symbol representing one service option of the software. The list is now retrieved by software 20 and is interpreted, making the licensed options ready for use. FIG. 4 illustrates a sample option list 400. Integers are used as symbols to facilitate explaining the operation of software 20, but any kind of symbol may be used so long as the software is able to interpret it. In addition, simply interpreting option list 400 does not allow software 20 to provide the full functions of those options. One more piece of data is retrieved from smart card 30—the cluster of code binaries 270 that is missing from the software. These binaries must be retrieved by software 20 at appropriate times for the software to operate normally. This imposes another obstacle to someone who tries to bypass the smart card licensing.

Operation of the Software

Once activated, software 20 allows full access to its specified options. Smart card 30 is expected to remain in the card reader while the software operates. Software 20 looks for the card periodically to ensure that it is indeed still in place. This periodic check is important because it prevents unauthorized users from using one smart card to run multiple copies of the software simultaneously. Failure to do so defeats the purpose of licensing.

In one illustrative variation, software 20 may be programmed to temporarily tolerate a missing smart card 30 (such as when the card is accidentally removed from the reader) and issue warnings to the user. Only after such warnings are repeatedly ignored does software 20 take action to cease operation.

Addition and Transfer of Software Options

Software vendor 10 issues each smart card 30 specifying a defined set of licensed options 260. In the illustrative embodiment (see FIG. 4), smart card 30 includes base software functionality, replication, and time marking for five clients (client support=5). However, there may come a time when the user desires to have more or different options from those that are included with the smart card. Such an instance requires an option transfer to take place. This is done by issuing a new smart card 500 having an option list 560 that indicates the newly requested options as the only options licensed. Smart card 500 does not need to know what options the original card 30 has. As far as card 500 is concerned, all other options are not licensed.

Option transfer can occur between any two smart cards issued by the same vendor 10. The categories of information stored inside one smart card are exactly the same as another. Consequently, any one of the cards can be used as a “master card” that activates and keeps the software running. Options from several cards can all be consolidated into one “master card” if desired.

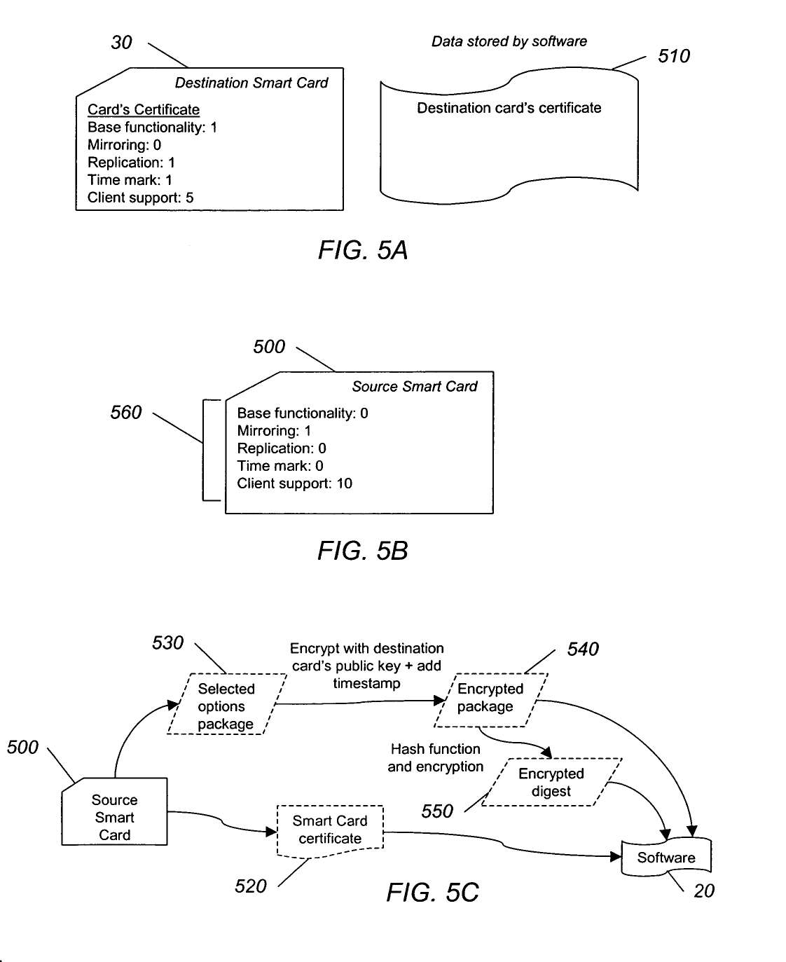

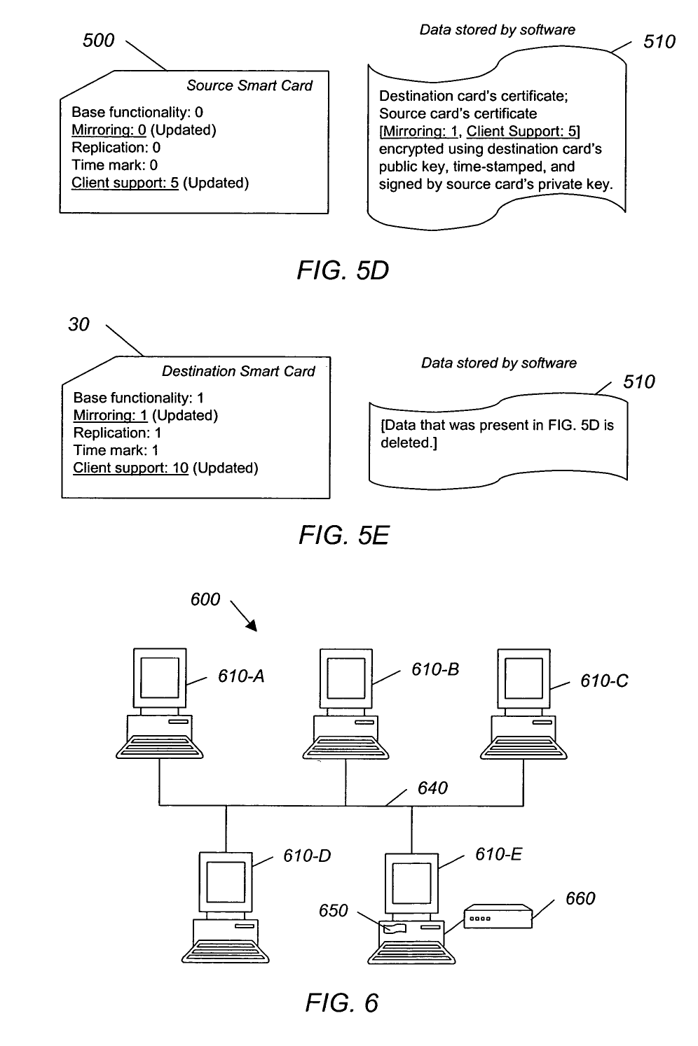

The actual transfer process begins by reading the intended destination smart card 30. Software 20 authenticates card 30 (as described with respect to FIGS. 3A and 3B), retrieves its smart card certificate 220, and stores certificate 220 in a separate, temporary location 510 (see FIG. 5A) on the computer running the software. Next, software 20 prompts the user to place source smart card 500 in the card reader and the software authenticates card 500 as was done in FIGS. 3A and 3B. FIG. 5B shows a source smart card 500 having licensed options “Mirroring” and “Client Support=10.”

Software 20 lets the user choose the actual options desired to be transferred, and then informs source card 500 of the selections made, passing along the destination card's certificate 220. Source card 500 now prepares to export those options. To ensure a destination card issued only by vendor 10 can import the options, source card 500 first authenticates received smart card certificate 220. Then source card 500 puts data representing the selected options 560 into a selected options package 530 (see FIG. 5C), encrypts selected options package 530 using the destination card's public key, and timestamps the package, producing encrypted package 540. Only the smart card containing the destination card's public key will be able to decrypt and use the options (using the destination card's private key). Then, source card 500 digitally signs encrypted package 540 using a hash function and source card 500's private key, producing encrypted digest 550. Both encrypted package 540 and encrypted digest 550 are transmitted to software 20 along with source card certificate 520 (containing the source card's public key).

As soon as options are exported, they are removed from source smart card 500 so that the same option cannot be transferred more than once. FIG. 5D shows the resulting state of source card 500 after these steps, assuming the user has selected “Mirroring” and “Client Support=5” to transfer. Source smart card 500 is updated (Mirroring=1−1=0 and Client Support=10−5=5) and then put away.

Software 20 authenticates destination card 30 again, and transfers encrypted package 540 and source card certificate 520 onto it. Destination card 30 first makes sure encrypted package 540 comes from a smart card issued by vendor 10 by verifying the source card certificate 520 using the vendor's root certificate stored inside each card, and then authenticates encrypted package 540 using encrypted digest 550. Once encrypted package 540 is authenticated, destination card 30 decrypts the package using the destination card's private key and accepts the new options. This completes the transfer process. FIG. 5E shows the status of smart card 30, including Mirroring=0+1=1 and Client Support=5+5=10.

When transfer is complete, software 20 erases from memory 510 the data that was temporarily stored there. In order to prevent clever users from finding out how this transfer scheme works and copying the option package before software 20 has a chance to erase it (thereby repeatedly downloading the same card using its correct private key, e.g., to increase the client support count or the capacity supported), the present invention uses the timestamp previously placed on package 540. After importing the information from source card 500, destination smart card 30 records the timestamp and knows not to again import a package having the same timestamp. The destination card memory retains the recorded timestamps, but the memory is limited, so if a user transfers options often, the destination card memory may fill up. In that case, the user can export the entire contents of the card to temporary software memory and then re-import the contents onto another smart card issued by vendor 10. Cards whose memory for storing timestamps is used up may be discarded or returned to the vendor.

Use with Networked Systems

The above licensing system can be used with standalone computers or with networked or enterprise systems. However, use with networked or enterprise systems contemplates each networked computer having a smart card reader. In the event that each networked computer does not have a smart card reader, an alternate embodiment is described below.

Networked system 600 may include any number of networked computers 610 (five of which, 610-A, 610-B, 610-C, 610-D, 610-E, are shown in FIG. 6) connected to each other via network 640. Network 640 may be, for example, a local area network (LAN), a wide area network (WAN), a metropolitan area network (MAN), or an internetwork of computers, such as the Internet.

The alternate licensing scheme may be implemented using only one smart card reader 660 attached to one of the networked computers, here computer 610-E. This computer includes software, here called “console program” 650, that can be used to distribute the licenses to different machines running the licensed software program. Console program 650 can securely license options inside a smart card to each networked computer 610. A software package 21, which is slightly modified from software package 20 for use with this licensing scheme, includes an additional mechanism to internally generate a pair of asymmetric keys along with the corresponding certificate at the time software package 21 is loaded on each networked computer. The certificate contains the name of the networked computer to identify the keys with that machine. Console program 650 acts as a middleman during transactions between the smart card and software 21 installed on each computer 610. Each smart card is initialized and issued the same way as described in the previous embodiment. Thus, authenticating smart cards to verify that they are issued from vendor 10 is performed using the method described under “Activation of the Software.” To perform authentication, console program 650 includes a copy of vendor 10's certificate securely stored for reference.

Just as in the previous embodiment, a network or system administrator is issued one or more smart cards containing the licensed materials paid for. These smart cards can be purchased directly from vendor 10 or from a reseller. When a card is inserted into card reader 660, console program 650 authenticates the card and displays all the available license options. Console program 650 also finds all computers in network 640 that desire to use software 21. The system administrator chooses which license options to distribute to which computer 610. Once an appropriate computer is selected and options are assigned to it by the system administrator through the console program's interface, the activation process for that computer begins.

First, console program 650 asks computer 610 to provide a copy of the certificate the computer generated when software package 21 was first installed on the computer. Console program 650 passes this certificate to the smart card along with the selections made by the system administrator. Because in this embodiment licensing options are actually being exported, there must be a way for the options to be securely transferred back to the card when needed. Therefore, the options package contains not only the licensing options, but also a ready-made return package that allows the card to restore its options.

To produce the return package, the card encrypts the selected licensing options using its own public key so that no other card will be able to use the return package. A unique stamp is then added to the encrypted options, and the result is digitally signed using the card's private key. Such a stamp can be a timestamp as described earlier, or it can be any stamp that can be uniquely generated each time. The signature ensures that when the card later receives the return package, it will know that the package was not altered in any way.

Next, the card encrypts the selected licensing options again, this time using the passed-in certificate's public key, and attaches the same unique stamp to it. The result is the export package that the target computer will be able to decrypt and use. Lastly, the return package and the export package are combined and signed together using the card's private key, and the result is sent back to console program 650 along with the card's certificate. The unique stamp for this package is recorded inside the card, in a recording area different from the stamp history list for transfers between cards, described in the previous embodiment. This recording area exists only in this alternate embodiment. Console program 650 subsequently passes everything to the networked computer. The options exported are then deducted from the smart card.

When computer 610 receives the package, software 21 first verifies the signature on the smart card's certificate against the vendor's certificate to make sure this package comes from a valid smart card from vendor 10. Then the software verifies the card's signature on the package and tries to decrypt the package using the internal private key generated by software 21. Before decryption, software 21 makes sure the computer it is running on matches the computer name on its own certificate. Software 21 checks the timestamp to make sure that it did not already receive this package (the software maintains a list of timestamps for packages it already received and is using). Software 21 decrypts the export package, accepts the licensing options, and activates them accordingly. The entire package including the return package is stored securely in computer 610's memory for necessary checks and operations in the future (as described below).

Periodically, the activated software 21 performs a reaffirmation with the smart card, a step that is taken because of security issues related to software deactivation, described below. Reaffirmation involves console program 650 asking software 21 operating on a networked computer for a copy of its option package, the computer passing it to the smart card, and having the card check whether the random number stamp inside the package is stored in the card as one of the distributed packages. If so, then this computer is indeed licensed by this card. Otherwise, this computer either never received a licensed package from this card or is using a license package that has already been retracted.

This alternate embodiment introduces a feature that is not needed in the previous embodiment. In the previous embodiment, a computer is activated when the valid smart card is inserted into its attached smart card reader, and the smart card must remain in the card reader for the computer to remain activated. When the smart card is removed from the card reader, the software 20 is automatically deactivated. The options inside such a smart card do not change except when transferring options. In the alternate embodiment, however, activating the software on a networked computer 610 requires actual deduction of options from a smart card. The deducted options are physically transferred to the designated computer's memory where they remain. The receiving computer's licensed options are thus sustained once activated. There is no automatic deactivation.

This process works so long as the system administrator does not ever want to use these options on a different networked computer or change the options for this computer. Once a system administrator chooses to reallocate options within a networked computer or among networked computers, the options need to be taken from the current computer and redistributed accordingly. The current computer will then end up being deactivated unless some purchased options are again allocated to it.

To retract an option package, console program 650 tells the target networked computer to submit its package and destroy any remains of it in the system. To make sure that the receiving card is not some random smart card, however, the same card that initially issued the option package to the networked computer should be used. The target computer, the computer whose option package is being retracted, first generates a random number and sends it to the card as a challenge. The card digitally signs the number and returns the result. The target computer checks the signature against the card's certificate that was received along with the option package, and only agrees to give up the package when verification succeeds.

The package submitted by the networked computer does not need to be the entire package it received, but only the return package inside. When the smart card receives the package, it first verifies its own signature on the package. Then, it looks at the unique stamp. If the stamp matches any of the recorded stamps for distributed packages, then this return package is acceptable and the card decrypts the licensing options using its private key and restores them onto its array of options. The recorded stamp for this package is then removed from the list of timestamps the software maintains.

The present invention is not limited to the illustrative example of storage software licensing—the problems faced in software product licensing are experienced by any software vendor, especially major enterprise software vendors. The options and capabilities available may be tailored to the specific type of software being licensed. Vendors can generate their own certificates and public/private key pairs.

The present invention is also not limited to the illustrative example of public key cryptography as an authentication infrastructure. Other authentication infrastructures may be used, so long as they authenticate a user's smart card. Thus, biometric identification of a user may be used. Biometric identification uses physiological characteristics and behavioral traits for the automatic identification, or identity verification, of persons. In general, biometric identification requires sensors to convert a physical characteristic or behavior of a person into a signal that can be stored, or compared to previously stored signals, using a computer. Some examples of biometric identification include identifying a user by a fingerprint, a thumb print, an iris scan, a retinal scan, facial recognition, and DNA.

Additional advantages and modifications will readily occur to those skilled in the art. Therefore, the present invention in its broader aspects is not limited to the specific embodiments, details, and representative devices shown and described herein. Accordingly, various changes, substitutions, and alterations may be made to such embodiments without departing from the spirit or scope of the general inventive concept as defined by the appended claims.

1. A method for authorizing use of a software package distributed to a user, the method comprising:
issuing the user a smart card granting access to the software package; and
granting the user access rights to the software package by authenticating the smart card,
wherein the smart card includes at least one software module missing from the software package and a list of allowed software functionality.

2. The method according to claim 1, wherein the authenticating is performed using asymmetric cryptography.

3. The method according to claim 2, wherein the asymmetric cryptography is public key cryptography.

4. The method according to claim 3, wherein issuing a smart card comprises:
generating a public key and private key pair for the smart card;
issuing a digital certificate for the smart card, including the smart card's public key;
digitally signing the smart card certificate to produce an encrypted digest;
issuing a digital certificate for the vendor of the software package; and
loading onto the smart card the public and private key pair, the smart card certificate, the encrypted digest, and the vendor's certificate.

5. The method according to claim 4, wherein digitally signing the smart card certificate comprises:
generating a digest of the smart card certificate using a hash function; and
encrypting the digest using a private key of the vendor.

6. The method according to claim 4, wherein authenticating the smart card comprises:
decrypting the encrypted digest to generate a first digest;
generating a second digest by running a hash function on the smart card certificate; and
comparing the first digest to the second digest,
wherein if the first digest and the second digest are the same, the public key of the smart card certificate is authentic.

7. The method according to claim 6, further comprising:
using the smart card certificate's public key to send a challenge to the smart card; and
decrypting the challenge using the smart card certificate's private key.

8. The method according to claim 1, wherein the authenticating is performed using biometrics.

9. The method according to claim 8, wherein the biometrics includes scanning a user's thumbprint or iris.

10. The method according to claim 1, wherein the allowed software functionality comprises supporting at least one client.

11. The method according to claim 1, wherein the allowed software functionality comprises supporting at least one of mirroring and replication.

12. The method according to claim 1, further comprising operating the software package in accordance with the allowed software functionality included on the smart card.

13. The method according to claim 1, further comprising operating the software package by incorporating from the smart card into the software the at least one software module missing from the software package to produce a complete and operative software package.

14. The method according to claim 13, further comprising periodically checking the presence of the smart card in order to authorize continued operation of the software package.

15. The method according to claim 1, further comprising changing the allowed software functionality by issuing a new smart card.

16. The method according to claim 15, wherein the new smart card includes a list of additional allowed software functionality.

17. The method according to claim 16, further comprising authenticating the smart card and the new smart card using public key cryptography.

18. The method according to claim 17, further comprising retrieving the smart card certificate and storing it in a memory location.

19. The method according to claim 18, further comprising:
authenticating the smart card certificate;
placing into a package data representing the additional allowed software functionality;
encrypting the package using the smart card's public key;
adding a timestamp to the encrypted package; and
digitally signing the encrypted package to produce an encrypted digest.

20. The method according to claim 19, further comprising:
removing the additional allowed software functionality from the new smart card and storing it in the memory location;
retrieving the new smart card certificate and storing it in the memory location; and
authenticating the new smart card certificate.

21. The method according to claim 20, wherein authenticating the new smart card certificate comprises:
decrypting the encrypted package; and
adding the additional allowed software functionality to the smart card.

22. The method according to claim 1, wherein the software package is used on a computer network.

23. A system for authorizing use of a software package, comprising:
a smart card having at least one software module missing from the software package and a list of allowed software functionality, wherein a user is granted access rights to the software package by authenticating the smart card.

24. The system according to claim 23, wherein the authenticating is performed using asymmetric cryptography.

25. The system according to claim 24, wherein the asymmetric cryptography is public key cryptography.

26. The system according to claim 25, wherein the smart card further comprises a public key and private key pair generated for the smart card, a digital certificate for the smart card including the smart card's public key, an encrypted digest of the smart card certificate, and a certificate for the vendor of the software package.

27. The system according to claim 26, wherein the encrypted digest is generated by performing a one-way hash function on the smart card certificate to produce a digest, and the digest is encrypted using a private key of the vendor.

28. The system according to claim 23, wherein the authenticating is performed using biometrics.

29. The system according to claim 28, wherein the biometrics includes scanning a user's thumbprint or iris.

30. The system according to claim 23, wherein the allowed software functionality comprises supporting at least one client.

31. The system according to claim 23, wherein the allowed software functionality comprises supporting at least one of mirroring and replication.

32. The system according to claim 23, wherein the software package is operated in accordance with the allowed software functionality included on the smart card.

33. The system according to claim 23, further comprising a new smart card having a list of additional allowed software functionality.

34. The system according to claim 33, wherein the additional allowed software functionality is added to the smart card.

35. A smart card for authorizing use of a software package, comprising:
at least one software module missing from the software package; and
a list of allowed software functionality,
wherein a user is granted access rights to the software package by authenticating the smart card.

36. The smart card according to claim 35, wherein the authenticating is performed using public key cryptography.

37. The smart card according to claim 36, further comprising:
a public key and private key pair generated for the smart card;
a digital certificate for the smart card including the smart card's public key;
an encrypted digest of the smart card certificate; and
a certificate for the vendor of the software package.

38. The smart card according to claim 37, wherein the encrypted digest is generated by performing a one-way hash function on the smart card certificate to produce a digest, and the digest is encrypted using a private key of the vendor.
